(19) United States
(12) Patent Application Publication
(10) Pub. No.: US 2002/0002509 A1
(43) Pub. Date: Jan. 3, 2002

(54) Custom advertising and trade facilitation system for internet or e-mail implementation

(76) Inventors: Paul E. Wagorn, Victoria (CA); Wurtele Scott, Victoria (CA); Aaron J. McNeal, Victoria (CA); Jonathan Knopp, Whistler (CA); Jason Beckers, Victoria (CA)

Correspondence Address: ROBERT H. BARRIGAR, SUITE 290, 1675 DOUGLAS STREET, VICTORIA, BC, V8W 2G5, CA

(21) Appl. No.: 09/892,449

(22) Filed: Jun. 28, 2001

Related U.S. Application Data
(60) Provisional application No. 60/221,936, filed on Jul. 31, 2000.

(30) Foreign Application Priority Data
Jun. 30, 2000 (CA) 2313283

(51) Int. Cl. G06F 17/60

(52) U.S. Cl. 705/26

(57) ABSTRACT

A method and system for enabling users to post trade lead notices, view trade lead notices, and receive notification when a trade lead notice adhering to a criteria requested by the user becomes available. An e-commerce facilitator comprising a digital computer coupled to a communications network automatically generates and operates multiple linked associated websites (including websites whose display is presented in different languages) enabling users to gain remote electronic access to the services provided. The facilitator maintains a central database common to all associated websites used for storing trade lead notices, user profiles and a selection of advertisements. The facilitator correlates a sub-selection of advertisements with a particular user of the system dependent upon the data profile associated with that user. The facilitator also provides complement e-commerce services for users such as on-line auctions, integrated payment and shipping services, as well as website and catalogue hosting services.

### FIELD OF THE INVENTION

This invention relates to a custom trade facilitation system and associated custom advertising and notification systems for Internet or e-mail implementation.

### BACKGROUND OF THE INVENTION

Someone looking to buy a particular type of product or service is usually searching for up-to-date detailed information on a variety of such items in order to make an informed purchase. Equally, someone looking to sell a particular product or service is usually seeking information on customer preferences and on the sources of prospective customers and exposure to a variety of potential customers in order to optimize sales opportunities, and also, especially in the case of custom-designed products, to optimize the characteristics of goods or services that are likely to have maximum appeal to customers.

Many Internet websites offer a posting board service to help prospective buyers and sellers to connect with or at least learn about one another via the Internet. These websites allow users to post a notice of an offer to buy or sell a particular product or service and also allow users to browse through various posted notices to obtain information regarding products or services offered for sale or offered to buy. However, previously known websites offer few services beyond an on-line database of posted notices. Consequently, these websites offer little to help buyers and sellers to engage in business.

Furthermore, previously known websites tend to be somewhat primitive in design, and typically do not afford an automated means to update information in databases, nor do they provide an automated means to establish suitable linked websites or crossupdating of data in such linked websites.

Some websites offer various types of watch-and-alert services. Users who have subscribed to these services can arrange to have certain on-line “buy” or “sell” postings or other activities monitored. The user might further stipulate specified criteria such that when a certain on-line posting or other activity (an “event”) meet specified criteria, the user will be notified of the event. Usually the subscriber will be notified of the event via e-mail. Possibly, a copy of the event will be included in the e-mail message sent to the subscriber.

Often, websites combine advertising messages with data messages requested by users. Furthermore, these advertisements may be correlated in various ways to suit the user. For example, the selected advertisement may be correlated to the type of data requested by the user. For example, when operating a search engine, advertisements are commonly correlated with a keyword from the search query.

Linking of websites is also commonplace. A website operator who operates a series of linked websites connected to a single database provides various access addresses or gates whereby a user can gain access to a single website from each of these access addresses. In such arrangements, a user accesses a given website only to be transferred to some linked website either automatically, or by way of user selection if the user is given a choice.

What is needed is an e-commerce facilitator system that both integrates and improves many of the aforementioned characteristics of a trade/advertising Internet-based system. The system should be comprehensive, dynamic, readily adaptable, easy to use and should be tailored to the individual needs of the user.

### SUMMARY OF THE INVENTION

According to the present invention, a method and system are provided that enable users to post notices of products or services that they wish to buy or sell, find others' posted notices of a particular type of product or service that they wish to buy or sell, and view notices (sometimes herein referred to as “trade lead notices”) of products or services that they wish to buy or sell. In addition to categorizing and managing such trade lead notices, the system includes other characteristics that help prospective buyers and sellers engage in interactive trade, such as notifying a given user (a prospective buyer or seller) when a particular type of product or service requested by the user has becomes available. The system and method of the present invention can be used by businesses seeking new suppliers, businesses seeking to buy or sell products or services, businesses that are testing new markets, businesses looking for competitive prices or performance from suppliers, businesses looking for the latest trade leads, businesses who wish to monitor their competitors' offers, and entrepreneurs marketing their products or services for the first time.

According to the present invention, an e-commerce facilitator (hereinafter “facilitator”) operating a website permits a user to post, view, or receive a discrete notice (viewable on the website) of an offer to buy or an offer to sell, a specified product or service. In general, the facilitator comprises a general-purpose digital computer (or linked set of digital computers) and associated peripherals, including communications links and suitable interfaces, and one or more databases with which the computer interacts. The computer is programmed to provide the set of operations discussed in this specification.

Various related services that may optionally be provided through the facilitator's website or a linked associate website help the user to manage trade leads efficiently. Procedures for providing each of these related services are described in detail below. An underlying premise of the invention is an updatable database and an infrastructure including a suitable electronic means for relaying signals, the latter preferably comprising the Internet, although aspects of the present invention could be implemented in conjunction with smaller networks. While alternative embodiments of the invention include the possible use of wireless and voice interfaces, in the preferred embodiment of the invention, users interact with the system by means of one or more of the facilitator's websites; consequently, users need to have website access.

The websites operated by the facilitator may be dynamic in that every time a user makes a request to access a website, the HTML (HyperText Markup Language) code for the website display is automatically generated by the facilitator; that is, the facilitator runs a program that automatically generates the HTML code which is used by a browser to display the website for a user. In essence, the presentation to a person accessing the website operated by the facilitator is governed by a software program that may be interfaced by the user by means of the user's browser. In this specification, it should be understood that the term “website” includes a website whose presentation and interaction with the person accessing the website is dynamic in character in the sense described.

The websites operated by the facilitator present a range of options to the user.

Users may take full advantage of the system by registering with the facilitator. Users may register during an on-line Internet session by supplying specified useful information to be entered into a database maintained and managed by the facilitator. This information is used to generate user profiles and is stored in the database. After a user has registered, a user is permitted to post notices of offers, view others' posted notices of offers, receive notification of offers via e-mail, and may optionally direct the facilitator to perform various other functions as discussed below.

To post a trade lead notice that includes either an offer to buy or an offer to sell a specified product or service, a user first selects an appropriate category relating to the subject-matter of the offer. Various categories and sub-categories are defined by the facilitator, preferably at least in part in response to user demand. For example, two or more new categories may be defined or created by the operator when the number of notices posted to a previously existing category exceeds some fixed number set by the facilitator. Next, the user submits various notice details to the facilitator by means of the facilitator's website. This information is processed by the facilitator and may optionally be subject to scrutiny by the operator of the system as to category and content. The notice might then be translated into different languages and posted to one or more linked associate websites maintained by the facilitator. Such associate websites may be specialized by vertical market, by language, or otherwise to meet user demand.

To view a notice, in a preferred implementation of the method according to the invention, a user who has accessed a website of the facilitator must first select a specific service (e.g., post notice to sell, post notice to buy, view notices to sell, view notices to buy, view auction notices, etc.) and within such service selection, select also an appropriate category relating to the subject-matter of the notice. In response to this selection, the facilitator's website displays a list of notices maintained in a database, which notices correspond to that service selection and selected category. A user may select a particular notice heading from a displayed list to view a screen displaying more details of that notice.

Other aspects of preferred embodiments of the system of the invention include:

(a) A comprehensive monitoring and alert service;

(b) A customized advertising system;

(c) Subsystems and associated methodology to establish and update content, interface, and functionality of associated websites;

(d) Information linking service.

Aspect (a) comprises a notification service for users interested in a particular type of information or event; a user is notified when relevant data become available. Trade lead information or event criteria specified by the user may include a particular field of use, particular location of source of supply, bidding status of an auction, trade news or other such information. For example, a buyer may choose to receive an email notice every time a notice is posted that relates to a specific category of product or service that the buyer is interested in buying.

Specifically, in a preferred embodiment of the invention, every time a notice is posted, a bid is placed, or other such event occurs that corresponds to user-specified criteria, an email message is generated that includes notification of this event and is sent to the user. A copy of the notice, or bidding history or the like, may be included with the e-mail message. Furthermore, notification to the user may also include other data deemed relevant by the facilitator, such as one or more selected advertisements correlated to suit the user or the user-specified criteria, pursuant to aspect (b).

Aspect (b) permits selection of advertisements for users of the system who are most likely to buy, use, or otherwise benefit from the products or services offered in the advertisements. Selected advertising content accompanies information content directed to a particular on-line user. In a preferred embodiment of the invention, the associative coupling is based upon correlating target group data of that advertisement with user profile data compiled by the facilitator. User profiles are formed at least in part by information directly supplied by the user during an on-line registration session but also may be supplemented by statistics related to how a user utilizes the system. For example, if the user put in a query about the availability of cocoa beans for sale, then the advertising content to accompany the delivery of relevant data would be directed to food goods, and perhaps chocolate, in particular. Note that this associative coupling is done automatically by the applicable website software, and does not require any direct human intervention on the part of the website operator.

Aspect (c) relates to an architecture for managing many different websites tied to a common database. Specifically, although each associated website remains independent, and each can be independently accessed, the information content of any given website in a preferred embodiment of the system is tied to the information content of at least a master website and possibly other related websites. The trade lead data carried by associated websites may be restricted to subject-matter from particular categories or may include an interface translated into another language, or may be restricted to trade opportunities within a defined territory, etc.

For example, suppose that a user in France wants to purchase 1000 kilograms of cocoa beans. Such user would access an associated “FR” website for France and probably would interact on-line with such website in the French language; the user could post a French-language bid for cocoa beans. The “purchase” notice for this bid for cocoa beans would immediately become transposed to the master database and also would appear in an associated website related to food goods.

Expansion, modification and refinement of the bid posting service are possible and may be desirable. For example, the facilitator may provide a translation service for translating the notice into different languages. In this way, the bid notice could be translated into English in the master website and could, depending upon any constraints imposed by the bid, be translated into other languages for posting on websites associated with other languages. The notice may be translated either by a translation service operated by partners of the facilitator, or the translation of the notice may be done automatically by means of software. Translation software for automatic translation is previously known and can be used for simple translation tasks. It is expected that improvements and refinements of such software will continue, making increasingly attractive the coupling of website data of one sort to related data (possibly in another language) at a linked website. The basic concept of such automatic translation is not per se inventive, although it is novel to couple websites of the sort under discussion using automatic translation software, or even to couple such websites using direct human translation at least for non-routine translation tasks. The operator of the system may choose to extract a translation fee from the registered user if the user wishes to have details of a notice translated into another language.

Note that no human intervention is required to generate and tie associate websites together; both are done automatically. Note also that the master database can provide data selectively by category and other constraints for display at associate websites; it is not necessary for each website operated by the facilitator to have associated with it a discrete database for that website.

The foregoing aspect of the invention also relates to a method according to the invention for automatically creating new associate websites and updating associated website interfaces and functionality. Specifically, according to a preferred embodiment of the invention, each associate website is generated (in the sense that the display and interaction modes are generated, not in the sense that the website address or domain name is generated) by website-generation software using the same essential code. Various “tags” can be inserted around either functional or non-functional elements of the code. These tags indicate which elements are to be included, excluded, substituted, or translated for other elements in each of the associate websites. This code is then fed through a program that recognizes the tags, and that generates as many different associate websites as are identified and defined by the tags.

Aspect (d) permits the gathering of supplemental information relevant to the needs of the user. To help users obtain useful information from the range of services offered by the system, the facilitator according to a preferred embodiment of the system provides an information linking service. Specifically, each of a group of services offered by the facilitator deals with a range of categories. When a user requests information from a particular service relating to specific subject-matter, the facilitator may (automatically) search for similar subject-matter from other services. This second source of information is determined by means of a suitable “fuzzy logic” association. The facilitator may link this secondary information with information originally requested by the user. Both primary and secondary information are transmitted to the user in response to the user's request for the primary information. The facilitator's software can of course couple the primary information with several types of secondary information, optionally in a hierarchy of apparent relevance, and can couple the data provided with associated advertisements.

In this way, buyers and sellers can learn of trade leads efficiently and avoid the time required for searching through multiple websites. Other refinements and expansions included in the present invention may be readily apparent to those skilled in the art.

### SUMMARY OF THE DIAGRAMS

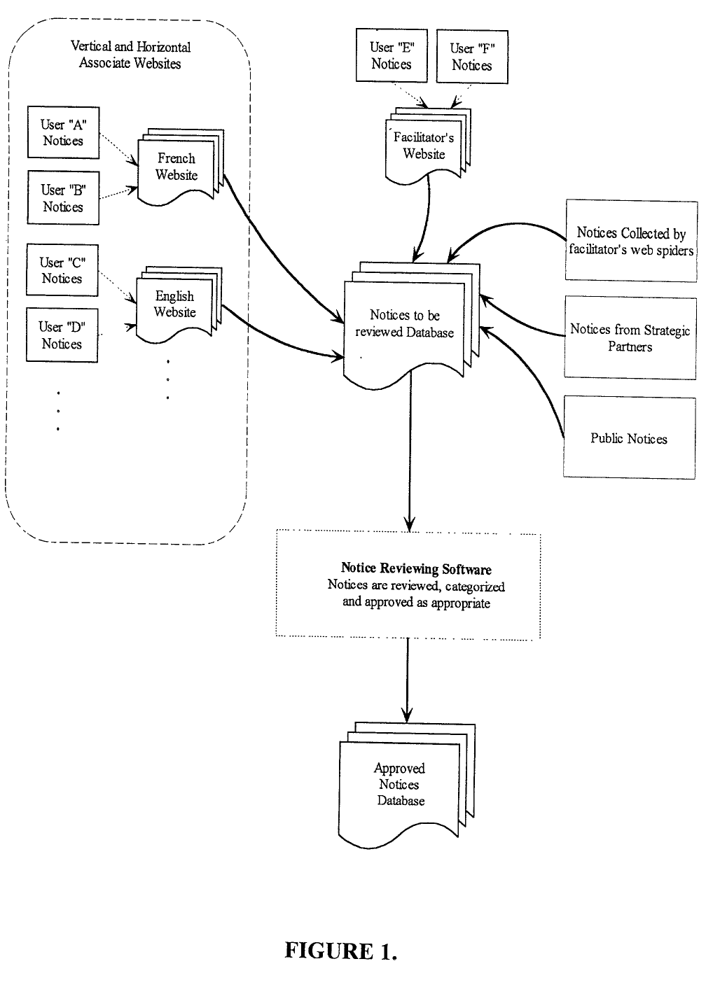

FIG. 1 is a block diagram representing a system according to an embodiment of the invention for gathering notices.

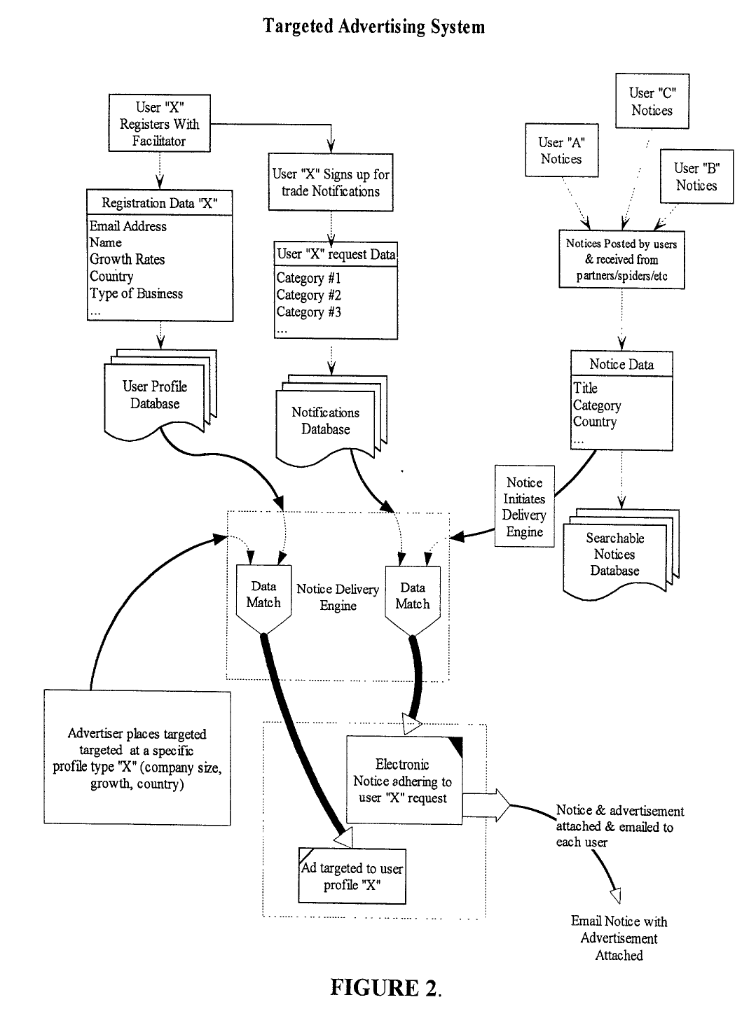

FIG. 2 is a block diagram/flowchart of an advertising system according to an embodiment of the invention for coupling to the notice display and delivery system according to an embodiment of the invention.

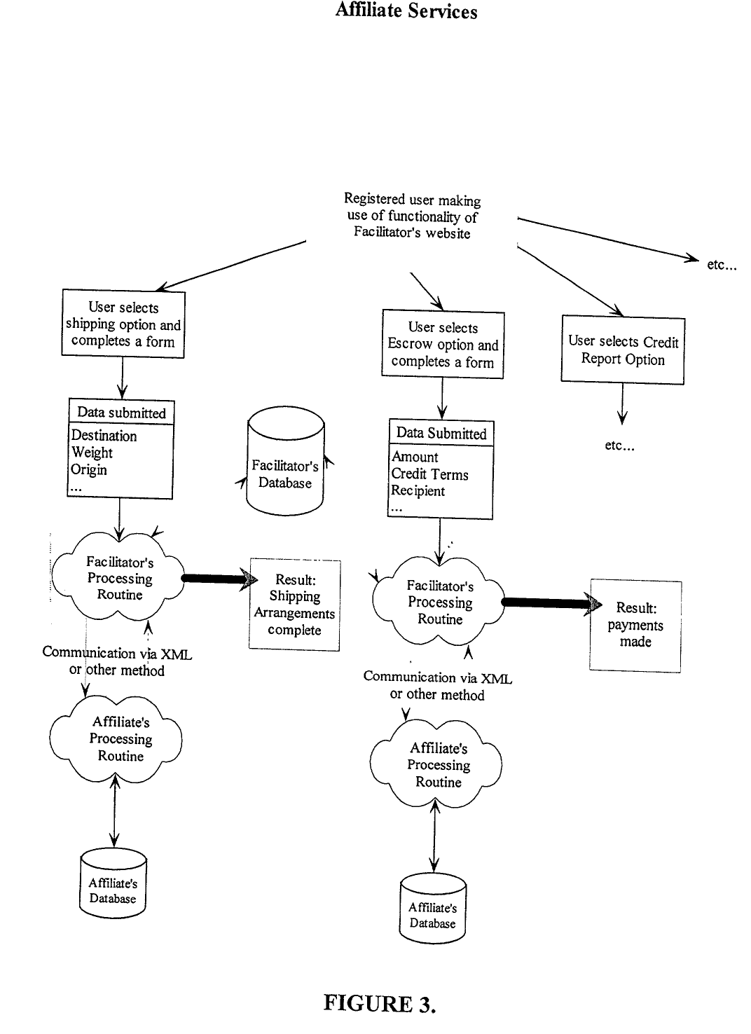

FIG. 3 is a block diagram/flowchart representing the coupling and integration of services offered by affiliate service providers into the website operated by the facilitator, according to an embodiment of the invention.

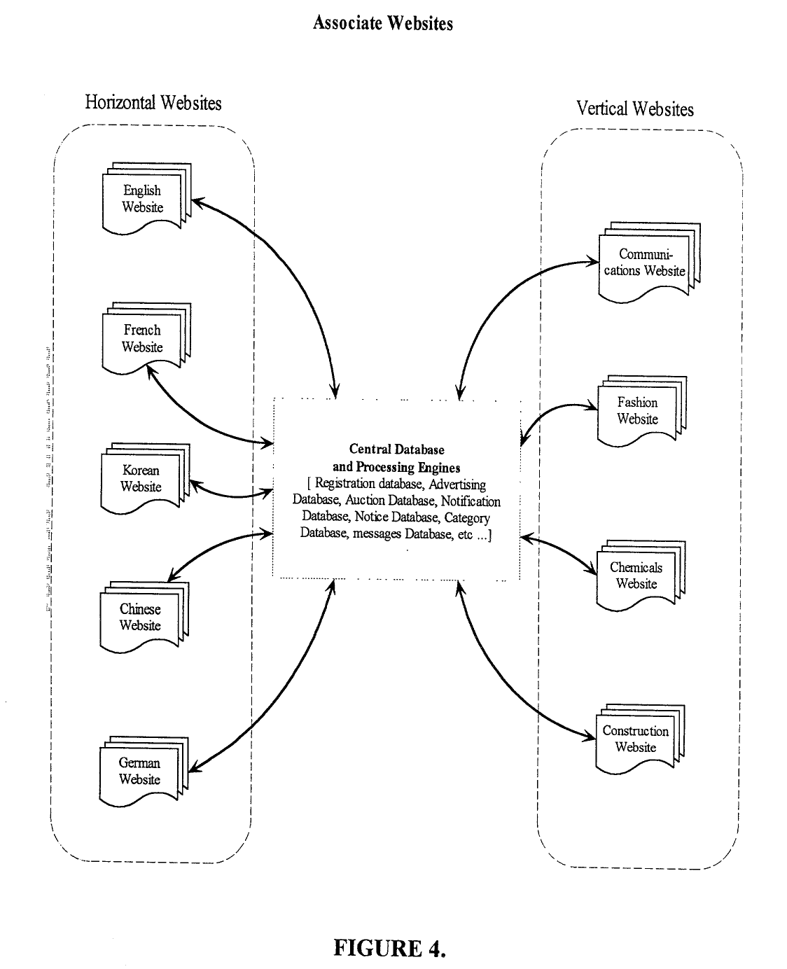

FIG. 4 is a block diagram representing a variety of different types of associate websites each sharing a common database, in conformity with an embodiment of the invention.

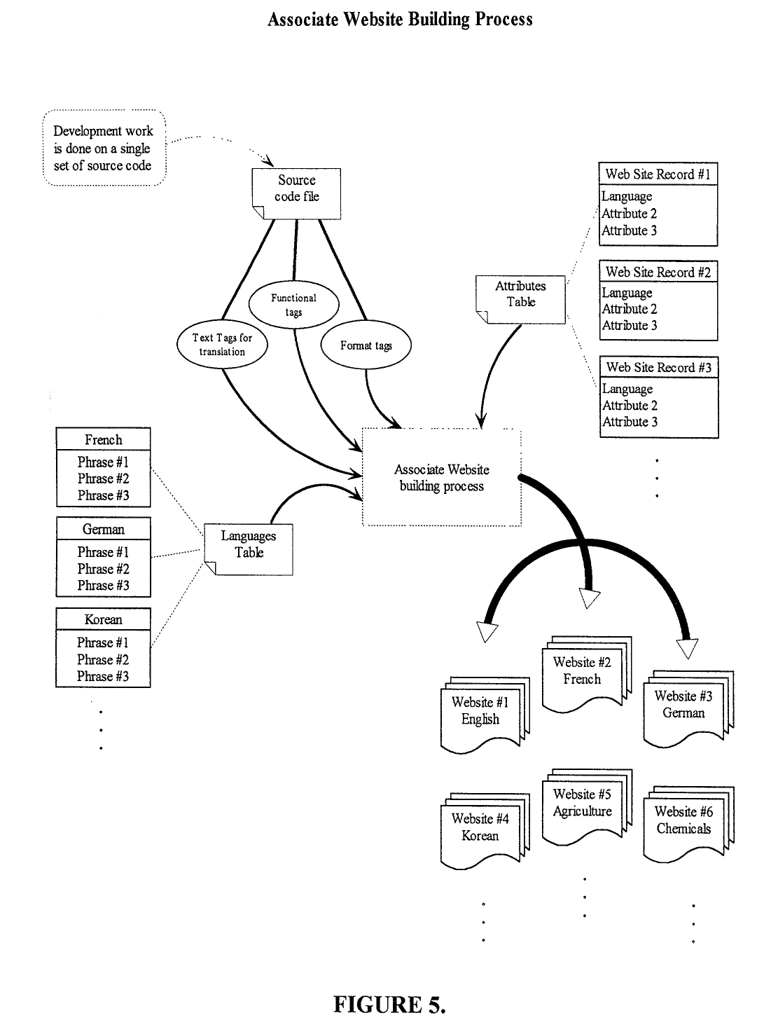

FIG. 5 is a block diagram/flowchart representing the process of building associate websites, in conformity with a method according to the invention.

### DETAILED DESCRIPTION OF PREFERRED EMBODIMENTS AND METHODS WITH REFERENCE TO THE DIAGRAMS

Introduction

As mentioned in general terms above, according to the present invention, a method and system are provided that enable users to post notices of given types for products or services they wish to buy or sell or otherwise deal with, find particular categories of product or services they wish to buy or sell, view notices of products or services available for purchase or sale (or the like; auction-related data and data relating to other possible transactions may also be included), and receive e-mail notification of a particular type of product or service offered in a notice. Other associated services help a user manage trade leads efficiently.

The e-commerce facilitator according to a preferred embodiment of the invention maintains a database and operates a website. Furthermore, the facilitator may also maintain various ‘horizontal’ and ‘vertical’ associate websites as described below; however, a single database may conveniently store all the data associated with the system regardless of how many websites are operated by the facilitator. According to the preferred embodiment of the invention, all services provided by the facilitator are available to the user by means of the Internet.

Registration

Using the Internet, members of the general public can access a website maintained by the facilitator. The website may allow limited access to aspects of the system for users who have not registered, or users who have not logged-in; only certain choices might be available for members of the general public. Among these choices for example, a member of the general public might be permitted to view details of notices relating to products or services offered for sale or offered to buy which have been supplied by businesses which offer these products or services. However, a user who has not registered may not be provided with an opportunity to respond to such a notice. If a user chooses to view such notices, the facilitator directs a user to choose a particular category among a list of categories relating to the subject-matter of the product or service offered in the notice. The user is then permitted to view certain details of notices which relate to this category. A user may note that certain articles are offered for sale, and may be permitted to view certain details of that sale; nevertheless, members of the public cannot, without becoming registered users, learn the details of any particular offer of sale or any particular bid. A member of the general public must register with facilitator in order to become a registered user and obtain additional information. A principal purpose of the registration requirement is to enable the facilitator to obtain a user profile that enables the facilitator to select for such user related data and advertisements that may be of interest to such user.

In order to become a registered user of the system, a user may be obliged to supply certain useful information during registration that enables the facilitator to generate user profiles. For example, when a user chooses to register, the facilitator may instruct that user to complete a number of data fields relating to certain registration information which may include the following:

1. E-mail address

2. User defined password

3. Company name

4. Type of business

5. Location of company

6. Number of employees

7. Contact name and phone number

8. Preferred language

The facilitator may request other types of information that relate to the future and direction of the user's company. Specifically, the facilitator might also request details about the size of the company, the type of the business of the company, the growth rate of the company, and the sales projections for the company.

The user then submits this information to the facilitator. The facilitator uses this information to create a user profile and then stores this user profile information in a database.

Although not included in the preferred embodiment of the invention, additionally, to become a registered user, a member of the public might also be a charged a registration fee. Such a fee could be payed to the facilitator by means of an on-line credit card payment, or some other Internet payment scheme currently under development.

When a user has successfully registered with the facilitator, a user can log-in as a registered user by supplying a user log-in name and a password. A registered user gains access to the following services and facilities of a preferred embodiment of the system which are described in detail below. (Note, however, that the system is not necessarily limited to these services and facilities; the operator may choose to add others, or may omit some of those listed below if they do not attract sufficient interest to merit their continuance.) A suitable complement of services and facilities is the following:

1. Posting notice service

2. Viewing notices service

3. E-mail notification service

4. On-line auctions

5. Catalogue hosting service

6. Services offered by affiliate websites

7. Document storage and transfer service

8. Integrated shipping arrangement service

9. Integrated payment service

10. Company websites hosted by the facilitator

11. Company “catalogues” hosted by the facilitator

12. Order and payment service for ordering from a company's catalogue

13. E-mail service for registered users

These services may be available to the user via various ‘vertical’ and ‘horizontal’ associated websites as described below. The services mentioned above may be supplemented by other trade-related services at the discretion of the operator of the facilitator.

Posting a Notice

Referring to FIG. 1, the system allows notices to be gathered from a number of sources. Notices may be posted by registered users either by means of the facilitator's main website, or by means of an associate website also operated by the facilitator. Additionally, as shown in FIG. 1, notices may be incorporated into the facilitator's database from other sources as well. Web spiders may be programmed to search the Internet for tenders, whereupon the data may be classified and incorporated into the data bank. Notices may also be automatically transferred from various affiliated organizations to the facilitator. Periodically, organizations that offer a continual supply of notices may electronically transfer notice data to the facilitator for immediate posting.

Important to note in FIG. 1 is that all notices submitted to the facilitator from any one of a number of sources is stored in a central database maintained by the facilitator. Each notice received by the facilitator may be subject to scrutiny by the operator of the system before the notice is incorporated into the website and viewable by users.

The subject-matter of the notice should relate to a particular item either offered for sale or offered for purchase. To post a notice, a user must be logged-in as a registered user. When a registered user chooses to post a notice, a registered user is first directed to choose a category pertaining to the subject-matter of the posting. Various categories are defined by the facilitator; categories may be supplemented and/or divided into sub-categories in response to demand and the choice of the operator. A registered user may search for the appropriate category using various search mechanisms or protocols; suitable Internet searching tools (“search engines”) of various sorts are previously known. The display screen for some of these search mechanisms could include a drop bar of various category choices, a category keyword search, or a category code search using either SIC code, harmonizing code, or NAICS code, for example.

The list of categories is defined by the facilitator and may be re-defined from time to time to suit the needs of users of the system. For example, if too many notices are being posted in a single category, the operator of the system may split that category into various sub-categories that subdivide that category. The operator of the system may choose a certain threshold level whereby when the number of notices to a particular category exceeds that threshold level, various sub-categories are defined. As such, the list of categories is dependent upon the types and numbers of notices that are submitted.

Once the appropriate category has been selected, the registered user may then be directed to provide details of the notice. The facilitator prompts the registered user to complete a number of data fields related to the content of the notice. These fields may include the following:

1. Indication of whether notice is of an offer to buy or an offer to sell;

2. Title/keywords of product or service;

3. Description of product or service;

4. The user identification number.

The user then submits this information to the facilitator. This data is stored in a database maintained by the facilitator for processing. Part of this process may require that notice data be reviewed by the operator of the system. Notices might need to adhere to certain criteria for approval:

1. A notice should be posted to the correct category.

2. Notice content should be of a business-to-business nature and should include specifics on items offered or sought.

3. Notices should include adequate contact information.

4. Notices should not include abusive, derogatory or obscene matter.

Approved notices are posted to a website maintained by the facilitator. With each notice, the facilitator automatically generates a date and a unique identifier number. The facilitator maintains a database of all such notices.

Viewing a Notice

A website maintained by the facilitator allows registered users to view notices that have been posted. When a registered user chooses to view complete details of a notice, a user must first have been logged-in as a registered user. The registered user must also indicate whether it wishes to view notices of offers to buy or offers to sell. Next, the facilitator directs the registered user to choose a category relating to the subject-matter of the notice. The facilitator provides a list of various categories. Using various search mechanisms as described above, a registered user chooses the appropriate category. Further, the registered user may specify additional limiting criteria; for example, both geographic origin and goods or services categories would be major limiting criteria, and subordinate limiting criteria may be offered to customers from time to time.

Additionally, the facilitator may provide a rating service for user companies who use the system. In this way, a user may limit the search subject to the company rating. The company rating may be based on a credit rating or other indicators of a desirable potential trading company. The facilitator could also divide users into “small business” and “large business” categories, for example, to further refine the primary and secondary data supplied in response to a user's request, or to establish a hierarchy of provision of such data. Such a hierarchy can be devised based upon feedback obtained from users of the system.

The user submits the category and other possible limiting criteria to the facilitator. The facilitator then provides the registered user with a list of the notices related to that category and other criteria. The list includes the name of the item as well as a short description. Accompanying this list, the facilitator may also display an advertisement for the user which is selected as described below.

By choosing a particular notice heading from this list, a registered user can view all details of the notice which may include the title, the date posted, the complete description of the object, the company name, contact name, and a telephone number and other similar related data. Along with this information, the facilitator provides the user with an option to obtain shipping information and an option to download bid documents relating to the notice. The notice may also be accompanied by an advertisement selected as described below.

Registered users who wish to buy or sell a product or service described in a notice can do so directly by means of a responding service provided by the facilitator. To respond to a particular notice, the user chooses the respond option which is linked with the appropriate notice. The user is then provided with a blank text area to write a response. The user submits this text to the facilitator which generates an e-mail message that is sent to the appropriate author of the notice. No user, whether registered or not, is permitted to see the actual e-mail address of the author of the notice. The facilitator withholds the e-mail address for a number of reasons primarily relating to security. Primarily, however, by not displaying a user's e-mail address, competitors cannot readily use notice data obtained from the website operated by the facilitator. That means robot spiders are kept off the website, thereby decreasing the server load significantly. Furthermore, the facilitator may wish to have transactions proceed via the facilitator so as to be able to control associated advertising and possibly so as to exact a transaction fee. In the preferred embodiment of the invention, registered users make their own deal with the supplier of goods or services, or the bidder of goods or services, as the case may be.

Receiving a Notice along with Targeted Advertising

In addition to notice posting and notice viewing, the facilitator also may also provide various associated optional services for the registered user such as e-mail notification whereby the facilitator supplies e-mail messages to those registered users who have expressed an interest in learning about notices of offers to buy or offers to sell products or services relating to specific types of goods or services.

Referring to FIG. 2, a registered user may choose to receive notification of a particular type of notice by submitting to the facilitator notification request data relating to categories or other criteria associated with the requested notice.

With this data, the facilitator performs a monitoring service relative to the certain categories of products or services, and within such categories for various subcategories and so forth as indicated by the user. Whenever a posted notice fits the specified criteria, a copy of the notice may be sent to the registered user via e-mail. Important to note in FIG. 2 is that the posting of a notice initiates the comparison between notice data and notification request data submitted by users to determine whether a notice should be forwarded to a user.

By way of example, a registered user might express an interest in any offer to sell raw cotton. Optionally, the user might further stipulate an interest in such offers but only if the offer is made by an enterprise operating in the Southeast United States. The information sought by such customer can be sent to that customer's e-mail address each and every time data relating to the category of goods or services in question is posted on the website.

Also shown in FIG. 2, additionally included in the e-mail message, the facilitator may incorporate one or more advertisements. The facilitator maintains a selection of advertisements as well as data relating to the desired target group of each advertisement so that on an automated basis, the facilitator is able to provide advertisements selectively, depending upon the user profile. As indicated in FIG. 2, a given advertisement may be correlated to the registered user profile of the sort of person who would be looking for information of the kind being delivered, and may be correlated with the category of goods and services and type of query selected by the user. For example, suitable information included in a user profile used for correlating an advertisement with the user could include both the type or the size of the user's business. As shown in FIG. 2, when a notice and an advertisement have been matched by the facilitator for transmission to a particular user, both the notice and the advertisement are formatted into an e-mail message that is sent to the user.

To receive notices of offers to buy or offers to sell, the user needs to be logged-in as a registered user. A user chooses to receive notices either related to offers to buy or offers to sell, or conceivably both. For each type of offer, the user then selects a category and possibly other limiting criteria or preference as to desirable notices in the manner as defined above. The user may choose to instruct the facilitator to perform several different notice-monitoring services relative to a range of specified criteria. The user submits this information to the facilitator. The facilitator stores this information in a database. Certain particulars of every notice subsequently posted are compared with the criteria specified by the user. When a notice is posted that fits the criteria specified by the user, the facilitator automatically associates with the provision of the data requested a correlated advertisement to accompany the e-mail message.

Specifically, a selection of advertisements is stored in a database maintained by the facilitator. With each advertisement, selected particulars related to the target group of that advertisement are also stored in the database. Target group data are based on user-profile information; for each advertisement, an advertiser may specify the target group of that advertisement by choosing targeted user profiles. For each type of information included in a user profile, the advertiser may select appropriate ranges and particulars indicative of the target group. Target group data for each advertisement are correlated with user profile data.

In addition to the user information provided directly by the user to the facilitator during registration, user profiles may be further developed by noting various choices a user makes while using the website; as a user selects information concerning certain categories of product or service, or other types of limiting criteria, this information can also be recorded in the user profile as such information could perhaps also pertain to the character (in a commercial sense) of the customer. Other types of user statistics may also be noted, such as how frequently a user uses the system, and which services a user uses most.

From the various types of information included in a user profile, advertising companies may select any number of particulars included in a user profile to define target group data. In this way, advertisers can specify any combination of target groups ranging from no users to the entire population of registered users. For each advertisement, advertisers will generally choose a range of selected particulars of users profiles which are indicative of consumers who are most likely to buy, use, or otherwise benefit from the products or services offered in the advertisement. The operator of the facilitator communicates with prospective advertisers to optimize the implementation of this aspect of the system and its operation.

When the facilitator is required to correlate an advertisement with a particular user, the facilitator will compare the user profile with target group data from a range of advertisements and select the advertisement which corresponds best.

Once an appropriate advertisement has been selected to accompany an e-mail notification, the facilitator generates an e-mail message to send to the registered user. E-mail notifications may include the relevant notice of offer to buy or offer to sell, a correlated advertisement, and perhaps other information either deemed appropriate by the facilitator or requested by the user. This e-mail is then sent to the registered user.

Auction

Through the data maintained by the facilitator and the selection of customers who use the system, the facilitator can arrange not only the posting of tenders, but also on-line auctions. A registered user may both place a bid on an existing auction or create a new auction.

A user who wishes to make a bid on a particular type of product or service may post a bid through the website. First a user must be registered with the facilitator. The user then selects a category relating to the subject-matter of the product or service on which the user wishes to bid. The user can then obtain a list of the items included in that auction. The facilitator provides several ways to list the items in an auction. For example, the user may select to view a list of the auction items which are sorted by the start date of the auction, by the end date of the auction, or by the amount of bidding in the auction for an item. For each item in the list, the user may be provided with a view of the following:

1. The name of the item

2. The current bid on the price

3. The number of bids on that item

4. Time remaining to make a bid on that item

5. Details about the owner of the that item

6. Details about each of the bidders on that item

7. The bid history of that item

8. Any comments or feedback from the owner of the item

When a user chooses a particular item from that list, the facilitator provides a complete bid history of that item. If a user chooses to make a bid, the user must submit the following:

1. bid per unit; and

2. unit quantity.

The facilitator stores this information with other bid history.

To create an auction, a user selects a category as described above. The user then must complete a range of information which may include:

1. Indication whether auction is to buy or sell

2. Title

3. Description

4. Opening bid

5. Reserve price

6. Number of units

7. Website address

8. Payment terms

9. Shipping terms

10. Item location

11. Auction length

This information is then submitted to the facilitator for processing. The operator of the system may choose to review the new auction notice before posting it on the website.

Website and Catalogue Hosting

The term “catalogue” in this context means an organized compilation of goods (or conceivably services) established by a user or by the facilitator. The facilitator may in accordance with an optional aspect of the invention offer an on-line catalogue hosting service. Such catalogue service allows a user to create and post the user's own on-line catalogue of items that the user wishes to sell or buy. The facilitator stores each item listed in a catalogue separately. Consequently, these items may be categorized in a variety of ways and listed amongst items from other catalogues as well. The facilitator can display the catalogue listings from a single user-generated catalogue or may compile items from various catalogues together to enable both the facilitator and users to create custom catalogues including items from many sources.

To create a catalogue, the facilitator first requires that the user acquire or identify a web page. The facilitator provides a web page hosting service which may require the following information:

1. A profile of the organization.

2. Complete contact information.

3. A logo.

With this information, the facilitator automatically generates the user's web page and a web page link incorporated in the website operated by the facilitator. To post a catalogue to this web page, the facilitator provides a blank form for the user to supply catalogue information. Once the user has typed in appropriate product information, the user submits the completed form back to the facilitator. Each item in the catalogue may be stored in the database maintained by the facilitator as a discrete item. The facilitator posts the items listed in the catalogue on the user's web page.

A user may view the catalogue of buy/sell data broken down by categories, either created by the facilitator or possibly, according to the user's own custom catalogue design. Users may be able to define their own custom-made catalogues that will incorporate data from the total data bank maintained by the facilitator that correspond to the user's selection criteria.

Furthermore, once the user's web page and on-line catalogue have been established, the facilitator may provide various automated marketing services for the user. For example, the user can choose to have the facilitator automatically submit the user's web page to various Internet search engines. Or, the user can choose to advertise its product on the website maintained by the facilitator in the manner described above. Such an advertisement can be automatically linked to the user's web page.

Affiliate Services

Referring to FIG. 3, also integrated into the website operated by the facilitator are various affiliate services. The operator of the system may form strategic relationships with operators of other websites offering various complementary online services such as on-line escrow services or on-line shipping arrangement services as indicated in FIG. 3. Important to note in FIG. 3 is that these affiliate services offered by other companies are provided through the website operated by the facilitator and are preferably branded as the facilitator's own services or otherwise suitably identified as services that the facilitator is able to provide. The facilitator electronically provides necessary data and instructions for the affiliate services on behalf of the registered user. The affiliate services process the data and return a result to the facilitator, which in turn is presented or transmitted to the user. Because the facilitator maintains a database of user information, these auxiliary services may be customized by the facilitator for each user. Specifically, information requested from these auxiliary services may be partially of entirely supplied by the facilitator without the need to have the user enter the same data many times over.

Information Linking

The facilitator offers several services for the user (notice posting, e-mail notification, on-line auction, business directory, catalogue hosting). Each of these services deals with subject-matter from a variety of categories. Of the many services provided by the facilitator, the facilitator also offers a service to relate subject-matter from different services to a particular user; information from different services dealing with similar categories may be connected together and supplied to the registered user. For example, accompanying an e-mail notification may be a notice of pertinent auctions or accompanying a catalogue listing may be notices of offers to sell similar items. The facilitator might send the registered user associated data that the registered user may not have specifically identified in the registered user's request for data, but that is in some pre-selected way, considered to be pertinent to the kind of information that the registered user selects. This associative selection of additional data for the benefit of the registered user is made pursuant to a “fuzzy-logic” association or connection. Ideally, the user will be able to benefit from this additional information by using more features of the invention.

Furthermore, if the user makes use of two or more services offered by the facilitator where each service relates to the same product, information about this product stored in the database can be shared between services; information about the product stored in various data fields may be linked between two or more services so that any modifications to a data field incurred as a result of using one service is reflected in other services automatically. For example, if a product is both listed in a posted notice relating to an offer to sell and as an auction item receiving bids, the data fields relating to the price of the item may be linked together. In this way, the price of the product posted as a notice item can be automatically updated when a new bid is placed for the product as an auction item.

Associate Websites

Referring to FIG. 4, according to the preferred embodiment of the invention, the facilitator maintains a central database and processing engine tied to several associated websites which share that database. These websites are tied in that any data submitted from an associate website is submitted directly to the central database common to all associated websites. Likewise, all data provided to the associate websites is also supplied by the central database.

The associate websites operated by the facilitator are dynamic; every time a user makes a request to access an associate website, the source code for the website display and interaction, or an object code counterpart, is readable by a browser software program is automatically generated by the facilitator from a program using ‘parent’ website generating source code. In this way, associate websites are readily adaptable and updatable with current information.

Associated websites operated by the facilitator may differ by content, by interface, by functionality, or by the language presented on the display of the website. As indicated by FIG. 4, the facilitator operates two different general types of associate websites: vertical websites and horizontal websites. The content of websites may be “vertical” in the sense that these websites identify different specialized categories of goods or services; an associated website in a “vertical” website relationship may be restricted to subject-matter of certain broad categories such as, by way of example, communication products, fashion products, chemical products, construction products, etc. as indicated in FIG. 4. Websites that are “horizontal” are not restricted by subject matter but may require a special user interface; the website may be territorial by country and thus require an interface using text which has been translated into another language. A horizontal website thus presents a different “front end” or access, a different user interface, for the entire content of the central database. Specifically, that means the facilitator operates a variety of associate horizontal websites, each sharing a central database and operating with similar functionality, but differing in the language of text used in the interface of each website. Of course, the facilitator may also choose to operate various combinations of horizontal and vertical websites. For example, some horizontal websites may exclude certain services offered by other associated websites or may be restricted to certain categories of goods or services.

Although the various associate websites may be different from one another, and may operate to some limited extent independently (in the sense that a user can independently access any one of them), each website can be generated automatically using common source code. FIG. 5 represents the general method used to generate each associate website. Notice that many different types of horizontal and vertical websites may be generated using this method. Specifically, as shown in FIG. 5, the facilitator maintains an attribute table for all associated websites operated by the facilitator. Included in this table are a few particulars relating to the website such as the location of these sites on the server.

The websites listed in the attribute table may be automatically generated or updated through the use of “tagging” the source code and by means of “build” software . Different types of “tags” are inserted in the source code used to create a master website. These tags can be placed on either side of the text relating to certain elements of the source code. These elements may be non-functional text elements such as words and phrases displayed by the website interface, or they may be functional elements such as source code relating to the auction service. Indicated in FIG. 5 are three types of tags: text tags for translation, functional tags, and format tags. These tags indicate instructions for including, excluding or substituting these elements of the source code with other elements. The source code with the tags is fed through a build software program which recognizes the tags and generates various associate websites according to the tags.

For example, tags may be included around all interface text elements of the source code. This text relates to words or phrases displayed on the website for the user. These tags indicate the text which needs to be swapped for translated text when generating a website in another language. In that way, associate websites may be easily translated from one language to another.

Alternatively, tags might also be used to include, exclude or substitute functional elements. If a particular associate website requires a registration fee, tags are included around every part of the source code that refers to the registration fee. For a particular website, these tags will indicate that the registration fee tags should be enabled.

What is claimed is:

1. A computerized method for customizing advertising to be directed to targeted users, comprising the steps of:
establishing and maintaining a database in or interactively coupled with a host computer;
providing each said user with remote electronic access for transmitting profile data into the host computer, the profile data being associated with selected characteristics of the user;
storing in the database computer-readable data representative of a selection of advertisements and target information associated with the profile data and optionally with selected other data associated with targeted users;
based on the selected stored data associated with targeted users, correlating and coupling a sub-selection of the advertisements with selected ones of such users;
in response to user demand or action, transmitting or displaying the computer readable data of selected advertisements to the user.

2. A custom advertising system for directing advertisements to selected users of the system and for implementation over a telecommunications network comprising:
a server computer connected to the network, the server computer including or interactively coupled with a database for storing the following information: a selection of computer-readable advertisements, target data associated with characteristics of targeted users for each said advertisement;
user-operable means for inputting profile data into the input device as computer-readable data;
processing means within or coupled to the server computer for selecting a particular computer-readable advertisement from the database dependent upon a correlation between target data from a particular advertisement and profile data for the user;
means for transmitting or displaying the particular computer readable advertisement from the server computer to the user.

3. A user-accessible monitoring and notification method for implementation over a communication network and using a host computer, comprising the steps of:
defining and maintaining a database in or interactively coupled to a host computer;
receiving at the host computer request data from users via remote electronic access, and storing the request data in the database, the request data being associated with selected characteristics of notices requested by the users;
receiving at the host computer multiple notices of existing or potential commercial transactions, each said notice being received as computer-readable data;
comparing each notice with the request data for each said user; and
transmitting from the host computer an alert relating to a received notice to selected users when the received notice corresponds to the request data for such selected users.

4. A method as defined in claim 3 wherein the alert includes a copy of the notice or data representative of the contents of the notice.

5. A method as defined in claim 3 wherein the alert includes an advertisement.

6. A method as defined in claim 5 wherein the advertisement is selected dependent upon the user.

7. A monitoring and notification system for interaction with users of the system and for implementation over a telecommunications network, the system comprising:
a server computer connected to the network, the server computer including or interactive with a database;
means within or associated with the server computer for receiving request data from each said user, and correlating and storing the request data in the database;
means within or associated with the server computer for receiving multiple notices of existing or potential commercial transactions from users and optionally from other sources;
means within or associated with the server computer for comparing each notice with the request data;
means for transmitting an alert to a selected user when a notice corresponds with request data associated with such user.

8. A system as defined in claim 7 wherein the alert includes a copy of the notice or data representative of the contents of the notice.

9. A system as defined in claim 7 wherein the alert includes an advertisement.

10. A system as defined in claim 9 wherein the advertisement is selected dependent upon data and/or activity patterns associated with the user.

11. A method for automatically creating associate websites comprising the steps of:
establishing a server computer connected to the Internet;
defining at least one associate website location on the server computer;
creating a master source code for a master website;
inserting tags into the master source code text relating to aspects of the master website interface or functionality for exclusion or substitution in the associate website;
automatically generating the associate website source code by means of a “build” software program; and
generating an associate website from the associate source code.

12. A method or system as defined in any preceding claim, implemented in part via one or more linked associate websites presenting a selection of notices and advertising from within the database.

13. Each and all of the inventions hereinbefore described.
